(19) United States
(12) Patent Application Publication
(10) Pub. No.: US 2002/0077899 A1
(43) Pub. Date: Jun. 20, 2002

(54) Content download system

(76) Inventors: Hiroshi Kaneko, Tokyo (JP); Satoshi Igarashi, Tokyo (JP)

Correspondence Address: FRISHAUF, HOLTZ, GOODMAN, LANGER & CHICK, P.C., ATTORNEYS AT LAW, 767 THIRD AVENUE, NEW YORK, NY, 10017-2023, US

(21) Appl. No.: 09/793,348

(22) Filed: Feb. 26, 2001

(30) Foreign Application Priority Data
Feb. 28, 2000 (JP) 2000-50693

(51) Int. Cl. G06F 17/60; G06F 15/16

(52) U.S. Cl. 705/14; 709/219

(57) ABSTRACT

Disclosed is a content download system for downloading main content requested by a user and advertisement content in accordance with access time/date and a preference of user. The system comprises an input unit for obtaining the operational information from the user terminal, a log recorder for recording the operational information as the intrinsic log data of user, a data storage for storing identification data of main and advertisement contents as well as evaluation values indicating the selection criterion of main and advertisement contents for each user, a selection processor for selecting advertisement contents based on the evaluation value, an output unit for transmitting the requested main content and the selected advertisement content to user terminals separately, a measuring unit for measuring the progress time until acquiring of the operation input information, a unit for acquiring the current time from a system timer and a calculation unit for updating the evaluation value based on the log data, progress time and the identification data of the time range to which the current time belongs.

### BACKGROUND OF THE INVENTION

1. Field of the Invention

The present invention relates to a content download system for downloading contents such as audio and video data to a user terminal that may particularly be used for downloading advertisement contents via the public switched telephone network and/or the Internet.

2. Description of Background Art

A content download system blizing the public telephone line or the internet have generally been used for downloading contents such as audio and video data or the like to a user terminal such as a personal computer (PC), a cellular phone or a personal handyphone system (PHS). In such conventional content download system, banner contents for advertisement are transmitted to reproduce and display such banner contents on the user terminal until the main content (a content transmitted at the desire of the user) is selected at the user terminal or during the reproducing or displaying of the main content.

Since the banner contents are distributed on the one-way basis from the content download service provider, a user is not interested in such advertisement in many cases. Namely, from the viewpoint of a user, if a banner content is related to the main content to be downloaded by the user, such banner content is just the advertisement content the user hopes to receive.

Moreover, a user often has the desire to quickly receive the main content that has been provided by a creator or a provider the user knows very well and has never been received by that user.

In general, a kind of main content that is desired for download by a user tends to inevitably be changed depending on the time and date, namely on the time and day of a week and therefore, in fact, the users interest in the banner or advertisement content also changes statistically depending on the access time and/or date.

However, the conventional content download system is not adapted to provide any measure for selective quick download by a user of an interesting banner or advertisement content in accordance with the access time/date and user—s preference.

Moreover, in the conventional system, while the main content that is desired by a user for the download is completely received by a user terminal, the line connection time to the system server is often wasted and in some cases, there rises a problem that the main content cannot be received efficiently because various operational commands that are not required for selection of content are requested.

### SUMMAY OF THE INVENTION

It is a primary object of the present invention to provide a content download system that can solve various problems explained above and automatically selects and downloads the accurate content, particularly the banner or advertisement content depending on the access time/date and user's interest. It is another object of the present invention ito provide a content download system that can efficiently realize the download of the main content and/or advertisement content.

According to the present invention, the above-noted objects can be achieved with a content download system for downloading at least one main content requested by a user together with at least one advertisement content to a user terminal on the basis of the access from said user terminal, said system comprising:

input unit means for entering the incoming data from the user terminal into said system;

log recorder means for recording, as a log data intrinsic for said user terminal, the information appearing in the incoming data which corresponds to the input operation at the user terminal;

data storage means for storing identification data of a plurality of main contents and advertisement contents as well as a plurality of evaluation values for said identification data, each of said evaliation values indicating the intrinsic selection criterion by the user for each of the main contents and advertisement contents stored in said data storage means;

selection processor means for selecting an advertisement content on the basis of at least one of said evaluation values;

output unit means for transmitting a main content requested by the user to an address of the user terminal and also transmitting to said address of the user terminal an advertisement content independently selected by said selection processor means in addition to transmission of the requested main content;

measuring means for measuring the progress time passed from a predetermined period to a point in time when the operational input is made at the user terminal; and

evaluation value calculation means for updating the evaluation values on the basis of said log data and said measured time obtained by said measuring means.

According to the content download system of the present invention, a plurality of evaluation values for the identification data of a plurality of main contents and advertisement contents are generated and stored as the intrinsic data for each user, and the stored evaluation values are used as the selection criterion of the main contents and advertisement contents for each user. The stored evaluation values are updated on the basis of the intrinsic log data of each user and the progress time, for example, from the transmission start time of main content requested or selected advertisement content to a point in time when the operational input is made at the user terminal. Thereby, an advertisement content to be distributed at the time of next access will be selected on the basis of the selection criterion reflecting the user's preference to the main content or advertisement content. Therefore, in the next and subsequent distributions or downloads, the advertisement contents based on the user's interest can be selectively and automatically downloaded reflecting a degree of recognition and interest regarding main content of a user.

The advertisement contents used in the present invention implies the other whole kinds of contents to be downloaded together with the main content. For example, various contents of banners, advertisement or public relation for commercial use and the other purposes, contents displayed as a background image on the display unit in the receiving side or contents for guiding the main content to be distributed, are all included in such advertisement content.

Moreover, the main content requested by a user also includes the contents corresponding to the details of the content reproduced in the advertisement content.

The advertisement content and main content may contain audio data and/or image data including still or moving picture information. Preferably, these contents are downloaded in the compressed data format with the well known manner in the art.

The identification data is used for identifying each of the main contents and advertisement contents and it is possible to allot a plurality of identification data such as the subject field, name of creator, name of provider and time zone to be released or the like for individual main content or advertisement content.

Each of the evaluation values is an intrinsic or inherent characteristic value for each of the identification data in regard to each of the main contents and advertisement contents and these values are generated and stored for each user. In case where a plurality of identification data exists for one content, the evaluation value can be determined for each identification data. For example, when the three kinds of identification data such as subject field, name of creator and name of provider are determined for a single main content or advertisement content, the evaluation value exists for respective identification data. Each evaluation value can be set optionally and the number of times of selection of creator of a relevant content and the range of the number of times of selection, for example, may be set as the value of the evaluation level.

The selection processor means is not particularly limited in the practical structure so long as it can select an advertisement content on the bassis of the evaluation value. For example, it is possible to employ selection process different in accordance with the predetermined identification data for individual contents, such that the advertisement content having higher evaluation value is sequentially selected, or that the advertisement content having lower evaluation value is sequentially selected, depending on the identification data.

The output unit means is not limited particularly in the structure of the transmitting means itself so long as it can transmit the desired main content and advertisement content to the user terminals. For example, It may be optionally chosen by a person skilled in the ordinary transmission technique to achieve the transmission of each content to the mobile telephone users including PHS users through the telephone line and the transmission of such content to the personal computer of each user through the Internet.

The output unit means individually transmits the advertisement content selected with the selection processor in separation from the requested main content. In this case, it is possible that the advertisement content is transmitted while the content request is received with the entry unit after the access is made from the user terminal and moreover that the advertisement content is transmitted in parallel with the transmission of the requested main content in the case of transmission through the Internet, in such a manner that the advertisement content is reproduced as the other window image on the display unit of the user side computer.

The log data is picked up from the incoming data from the user terminal, which contains a log data relating to the operational input entered at the user terminal. As to the recording to the log recorder means, all operational log data in the incoming data may be recorded or the restricted operational log data for the requested main content and for advertisement content may also be individually recorded. As for example of the operational input at the user terminal, the depressing operation of the buttons in the mobile telephone including PHS terminal and the click operation of the pointing device or mouse for the icon on the display image or data input operation from the keyboard when the Internet is used with the personal computer. Of course, the canceling operation and skip operation at the user terminal are also a part of the operational log data.

The measuring means measures the time passed from a predetermined measurement starting period after incoming of access from the user terminal until a point in time when the operational input is made at the user terminal, and the measurement starting time and ending time point are not particularly limited. According to a preferred embodiment of the present invention, the measuring means may be constructed to start the measurement of time passed from the transmission start time, for example, of the requested main content or selected advertisement content. In this case, the measured time may be used as the evaluation reference to accurately indicate a degree of recognition and interest to each content by the user.

The evaluation value calculation means updates the evaluation values stored in the data storage means for individual users on the basis of the log data and the progress time produced in accordance with the second and subsequent incoming data, and its practical structure is not particularly limited. For example, the evaluation value calculation means may be constructed to decrease the evaluation value for the identification data corresponding to the content for which a comparatively longer progress time is measured on the one hand and to increase the evaluation value for the identification data corresponding to the content for which a comparatively shorter progress time is measured on the other hand, and vice versa. Moreover, the log data can also be formatted optionally to reflect in direct the number of times of selection for the content by the user on the evaluation values or to update the evaluation values only for the identification data for the specific content. A manner of increasing or decreasing the evaluation value depending on the measured progress time may be realized by preparing for a memory table to which the corresponding evaluation values are assigned to a certain constant or varying time duration or may be realized with the programmed function formulae. Update of evaluation values depending on the number of times of selection can also be realized in the similar manner as explained above.

According to the preferred embodiment of the present invention, the output unit means of the content download system transmits the advertisement content selected with the selection processor means to the user terminal during the period until the content request in the incoming data from the user terminal is picked up by the input unit means.

In this case, during the period from establishment of connection with the access by the user terminal until the content request appearing in the incoming data from the user terminal is picked up by the input unit means, the advertisement content selected by the selection processor means is transmitted. Therefore, under the service, for example, for the mobile phone or the like, the advertisement content just suited to a degree of recognition or interest for the main content by the user can be downloaded automatically on the basis of the current evaluation value during the period until the main content requested with the user is selected on the terminal.

According to another preferred embodiment of the present invention, the log data stored in the log recorder means includes the information relating to the number of times of selection by each user in the past for the main contents requested and the evaluation value calculation means is adapted to update the evaluation values stored in the data storage means on the basis of the information relating the number of times of selection and the measured progress of time for each access from the user terminal.

In this case, the system writes, for each access from users, the number of times of selection for the main content requested in the incoming data to the log data recorded in the log recording unit and the evaluation value calculating unit updates the evaluation value of each user stored in the memory unit based on the number of times of selection and the progress time. Therefore, when the same main content is requested in many times from the same user, the advertisement content to be transmitted in the next download is selected for the user based on the evaluation value in which the number of times of selection is reflected and thereby the advertisement content in which the interest and preference of the user are further reflected can be downloaded automatically.

The evaluation value calculating unit can be constructed to update the evaluation value corresponding to the number of times of selection for the main content and advertisement content accompanied by the identification data about the same kind as the identification data about all kinds corresponding, for example, to the requested main content. In this case, since a degree of recognition and interest of the user for the content can be assumed to be high not only for the requested main content but also for the same creator, provider and field same as those of the main content, the advertisement content to be downloaded in the next and subsequent downloads can more easily be accepted by users by updating the evaluation value based on the number of times of selection explained above.

According to still further preferred embodiment of the present invention, the log data recorded in the log recording unit includes the information about the canceling operation in the user terminal side for the main content and/or advertisement content transmitted to the user terminal and the evaluation value calculating unit updates the evaluation value stored in the memory unit based on the information about this canceling operation and progress time for each access from the user terminal.

In this case, the system extracts, from the incoming data from users, the information about the canceling operation in the user terminal side for the main content and/or advertisement content transmitted to the user terminal and then writes such data to the log data stored in the log recording unit and the evaluation value calculating unit updates the evaluation value of each user stored in the memory unit based on such canceling operation information and progress time. Therefore, a degree of preference, recognition and interest of the user for the transmitting content is determined based on the canceling operation information in the incoming data and the result can be reflected particularly on selection of the advertisement content in the next and subsequent downloads.

For example, when the information about canceling operation at the user terminal for the transmitting content (main content/advertisement content) appears in the incoming data, the evaluation value calculating unit determines that a degree of recognition of the user to the transmitting content is high and a degree of interest is low and then raises the evaluation value for all main contents and advertisement contents accompanied with the identification data in the same kind as every kind of identification data corresponding to the transmitting advertisement content. On the other hand, when the cancellation operation information does not appear, the evaluation value calculating unit determines that a degree of recognition of the user for the transmitting content is low and a degree of interest is high and lowers the evaluation value of the user to all main contents and advertisement contents holding the identification data about the same kind as the identification data about all kinds corresponding to the transmitting advertisement content.

This canceling operation information includes not only the information about canceling operation at the user terminal but also the information about skip operation for the transmitting content.

According to the still further preferred embodiment of the present invention, the measuring unit measures the progress time from a point in time when the operation input information from user terminal can be determined at the input unit until a point in time when the content request appears in the incoming data.

In this case, the progress time measured with the measuring unit almost corresponds to the period until the download request for the main content is generated from the end of access by user. Therefore, a degree of recognition and interest of the user to the main content can be reflected in direct on the evaluation value by updating the evaluation value in the evaluation value calculating unit based on the progress time and as a result, the advertisement content that is further fitted to the preference of the user can be downloaded automatically.

In this case, the evaluation value calculating unit determines, for example when the measured progress time is comparatively longer, that a degree of recognition of the user to the requested main content is low and a degree of interest is high and lowers the evaluation value to the main content and advertisement content accompanied with the identification of the data of the same kind as the identification of every kinds of the requested main content and also determines, when the progress time is comparatively shorter on the contrary, that a degree of recognition of the user to the requested main content is high and a degree of interest is low and raises the evaluation value to the main content and advertisement content accompanied with the identification data about the same kind as the identification data about every kinds of the requested main content.

According to the other preferred embodiment of the present invention, the measuring unit measures the progress time from the transmission starting time of the advertisement content until a point in time when the information about canceling operation to the advertisement content at the user terminal appears in the incoming data.

Namely, when the canceling operation to the advertisement content (skip operation) is performed at the user terminal side after the advertisement content is transmitted to the user terminal, the progress time during this period is measured with the measuring unit and the evaluation value calculating unit updates the evaluation value corresponding to the relevant user based on this progress time. As a result, in the next and subsequent downloads, the advertisement content where such progress time is reflected on the evaluation time can be selected and the advertisement content that is further fitted to the preference of the user can be downloaded automatically by determining a degree of interest of the user to the content of advertisement.

For example, it is possible to provide a structure that when the progress time until the canceling operation is rather longer, it is determined that a degree of recognition is comparatively low or a degree of interest is comparatively high and an evaluation value to the content and advertisement content having the identification data about all kinds of the requested contents is lowered and when the progress time until the canceling operation is rather shorter, it is determined that a degree of recognition is comparatively high or a degree of interest is comparatively low and the evaluation value to the content and advertisement content having the identification data about every kinds of the requested contents is raised.

As explained above, according to the present invention, the evaluation value is given to the identification data indicating the selection criterion of the main content and advertisement content for individual user, the advertisement content is selected based on this evaluation value, the requested main content is transmitted to users, the selected advertisement content is transmitted to users in separation to the transmission of this main content, the progress time from the predetermined time to a point in time of incoming of the information about the operation input at the user terminal is measured, the evaluation value is updated based on the intrinsic log data of the user and the progress time and thereby the advertisement content fitted to the preference of the user can be selectively downloaded automatically.

According to still further embodiment of the present invention, the content download system further comprises a timer for detecting the current time and a timer acquiring unit for acquiring, from the timer, the current time when the information about the operation input at the user side terminal appears in the incoming data, wherein the advertisement content is accompanied with the identification data about the time zone and the selection processing unit selects the advertisement content to be downloaded based on the evaluation value and the identification data in the time zone to which the current time belongs.

Namely, in this case, the current time when the operation input information of the user side appears in the incoming data is acquired with the timer acquiring unit and the advertisement content accompanied with the identification data in the time zone to which the current time belongs is selected and is then transmitted to the user side. Therefore, the advertisement content to be transmitted can be changed automatically depending on the access to the system server with a user terminal and date and time (the day of a week, time zone) of various input operations on the same user terminal, and this operation can be executed dynamically even during the active connection of the user terminal to the system. Accordingly, preferred advertisement contents can be downloaded automatically and accurately depending on the day of a week and time zone.

The time zone for individual identification data can be assigned electively and width of range can also be selected freely depending on the day of a week, an ordinary day, a holiday, a national holiday and a time zone or the like. For example, since it is probable that the interest of the user changes in the ordinary day and holiday, when the identification data about the time zone is set in the different manners to provide different time zones in the ordinary day and holiday, the advertisement content can more accurately downloaded automatically considering the changes in interest object of the user.

Moreover, in this case, since the advertisement content fitted to the preference of the user can be downloaded automatically depending on the day of a week and time zone, it results in the merit for the users that unwanted line connection time to the service provider can be shortened.

The present invention also provides a method for downloading at least one main content requested by a user together with at least one advertisement content to a user terminal on the basis of the access from said user terminal, said method comprising the steps of:

extracting the incoming data from a user terminal;

recording, as a log data intrinsic for said user terminal, the information appearing in the incoming data which corresponds to the input operation at the user terminal;

selecting an advertisement content on the basis of an evaluation value indicating the intrinsic selection criterion of the main content and advertisement content for said user;

transmitting the selected advertisement content to the user terminal during the period where the content request information appears in the incoming data from the user terminal and also transmitting to the user terminal the main content requested by the user when the content request information appears in the incoming data;

measuring progress time from the transmission start time of the selected advertisement content or of the requested main content to a point in time when the information about the operation input at the user terminal side appears in the incoming data from the user terminal; and

updating the evaluation value based on the log data and said progress time.

According to a preferred embodiment of the present invention, the content download method further comprises a step of acquiring the current time when the information about the operation input at the user terminal appears in the incoming data from the user terminal. In this case, the advertisement content is accompanied with the identification data about the time zone and the advertisement content is selected on the basis of both the evaluation value and the identification data about the time zone to which the current time belongs.

The content download method according to the present invention can be recorded on a computer readable recording medium as a software program to be executed with a computer system. Once the program is installed to the computer, the method can be executed with the computer system. Such a recording medium can be realized, for example, with a magnetic disk, optical disk, magneto-optical disk or semiconductor memory. Moreover, the program recorded on the recording medium can also be installed to a computer at the service provider site via the well known drive unit or network.

Other features and advantages of the present invention will become more apparent by reading the description of the preferred embodiments in conjunction with the accompanying drawings that is made to explain only an example with no intension of restricting the technical scope of the present invention.

### BRIEF DESCRIPTION OF THE DRAWINGS

FIG. 1 is a block diagram illustrating a hardware structure of an audio content download system as a preferred embodiment of the present invention.

FIG. 2 is a function block diagram of the software composition of the audio content download system of the embodiment.

FIG. 3 is a flowchart of the audio content selection and reproduction process in the embodiment.

FIG. 4 is a flowchart of the evaluation value calculation process in the embodiment.

FIG. 5 is an explanatory diagram illustrating a data format of audio content in the embodiment.

FIG. 6a is an explanatory diagram illustrating the basic index structure for management of audio content data in the embodiment, and FIGS. 6b to 6e are explanatory diagrams illustrating the other index structure of a plurality of categories for management of the audio content data after starting of the program.

FIG. 7 is an explanatory diagram illustrating content of evaluation value group in the embodiment.

### DESCRIPTION OF THE PREFERRED EMBODIMENTS

The preferred embodiments of the content download system and a method of download using the same system of the present invention will be explained below in detail. An embodiment explained below is only an example where the present invention is applied to the system for downloading the audio content data to the user terminals such as cellular phones including PHS via the public telephone network but the present invention is not limited thereto.

Hardware Structure of Audio Content Download System:

First, the hardware structure of the audio content download system according to this embodiment will be explained with reference to FIG. 1.

As shown in FIG. 1, the audio content download system 100 has an overall hardware structure utilizing a computer and comprises a control unit 101, a storage unit 102 connected to the control unit, a memory unit 103, a timer unit 104 and a communication unit 105.

The control unit 101 is formed of an arithmetic processor unit including CPU and ROM or the like to control the entire system. The memory unit 103 includes a plurality of ordinary RAMs.

The storage unit 102 comprises a nonvolatile memory medium such as a nonvolatile RAM and hard disk (HD) or the like, and a hard disk drive (HDD) or the like to perform the read/write operation to the hard disk (HD). The storage unit previously stores various content data, user data and log or history data of the user operation or the like. The storage unit 102 constitutes the data storage means and log recorder means defined in the present invention.

The timer unit 104 uses a real-time clock associated with a battery-backup and acquires the current time at the desired point in time. The communication unit 105 includes an audio data input-output interface and data convertors for the audio data.

The audio download program to be executed in the audio content download system of this embodiment can be provided to the computer installed in the service provider side via the network using an installable/executable file format. Also, update of various programs and data can be realized through the network. In addition, the audio download program, various programs and various data can also be provided by recording these in the portable recording medium such as CD-ROM, DVD-ROM or FD in the form of an installable file format to the computer of the service provider. In this case, the programs are installed to the computer of the service provider via the CD drive, DVD drive or FD drive.

Functional Structure of Audio Content Download System:

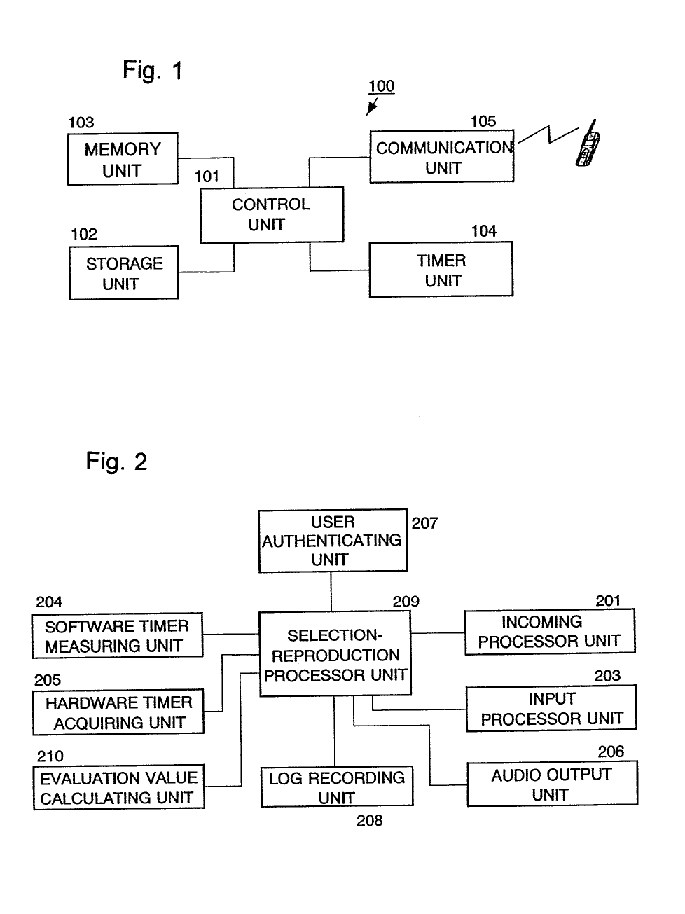

Next, the functional structure of the audio content download system 100 according to this embodiment will be explained. FIG. 2 is a function block diagram showing the software composition or functional structure of the audio content download system 100 of the present embodiment.

As shown in FIG. 2, the audio content download system 100 of this embodiment comprises an incoming processor unit 201, an input processor unit 203, a software timer measuring unit 204, a hardware timer acquiring unit 205, an audio output unit 206, a user authenticating unit 207, a log recording unit 208, a selection/reproduction processor unit 209 and an evaluation value calculating unit 210.

The incoming processor unit 201 monitors a plurality of network lines to wait for the accesses from the hand-held telephone users. When access is made from a user, the incoming processor 201 generates a task to assign it to the incoming line. The task forms the trunk part of the process for each user based on a scenario data and calls the input processor unit 203 for entering said incoming data from the user terminal, software timer measuring unit 204, hardware timer acquiring unit 205, audio output unit 206, user authenticating unit 207, log recording unit 208 and selection/reproduction processor unit 209.

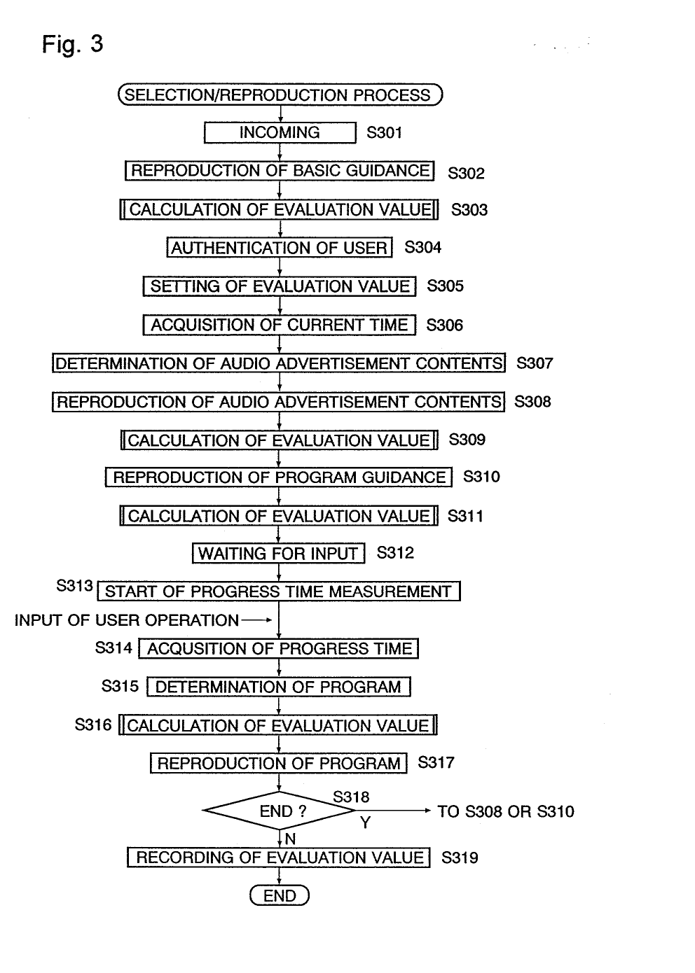

The scenario data is preliminary stored in the incoming processing unit 201 as a basic data or program describing each content reproducing sequence as shown in FIG. 3. Each task calls the processing sequence on the basis of the description the scenario data, thereby executing the download of the selected content data.

The input processor unit 203, which constitutes the input means in the present invention, monitors the user operation input information such as DTMF audio signals or the like appearing in the incoming data from the cellular phone or PHS and then acquires the user operation input information to notify it to the selection/reproduction processor unit. Operation of this input processor unit 203 is executed for individual task during execution of the task.

The software timer measuring unit 204, which constitutes the measuring means in the present invention, measures the progress time from a predetermined point in time. The software timer measuring unit 204 also produces a temporal data including the preceding application time of the same user.

The hardware timer acquiring unit 205, which constitutes the timer acquiring unit in the present invention, acquires the current time from the timer unit or clock device in the system. The audio output unit 206, which constitutes the output unit means in the present invention, transmits the audio content data previously stored in the storage unit 102 to users. The user authenticating unit 207 identifies the user terminal that has made access to determine the initial value of the content scenario. The log recording unit 208 sequentially records contents of operation input information at the user terminal side for each user with progress time.

The selection/reproduction processor unit 209, which constitutes a selection processor means in the present invention, selects and reproduces the advertisement audio content data, background audio content data and program audio content data. Here, the advertisement audio content data and background audio content data correspond to the advertisement content in the present invention, while the program audio content data corresponds to the main content in the present invention.

The evaluation value calculating unit 210 calculates an evaluation value from the progress time measured in the software timer measuring unit and log data of the user operation and user operation content recorded in the log recording unit in order to update the preceding evaluation values already stored.

Format of Audio Content Data:

FIG. 5 schematically illustrates the data format of the advertisement audio content data, background audio content data and program audio content data used in the audio content download system of the present embodiment. As shown in FIG. 5, each content data is formed of audio data and a plurality of identification data for each content data. The identification data is composed of a field data indicating the field of the background audio content data, advertisement audio content data and program audio content data, a creator data indicating a creator of the audio data, a provider data indicating the provider of the audio data and a time zone data indicating the time range for downloading the audio content data. The identification data regarding the other kind of informations can be additionally set if necessary. Moreover, in this embodiment, a plurality of identification data are added to the header part of content data but the similar effect can also be attained by adding such identification data to the hooter part thereof.

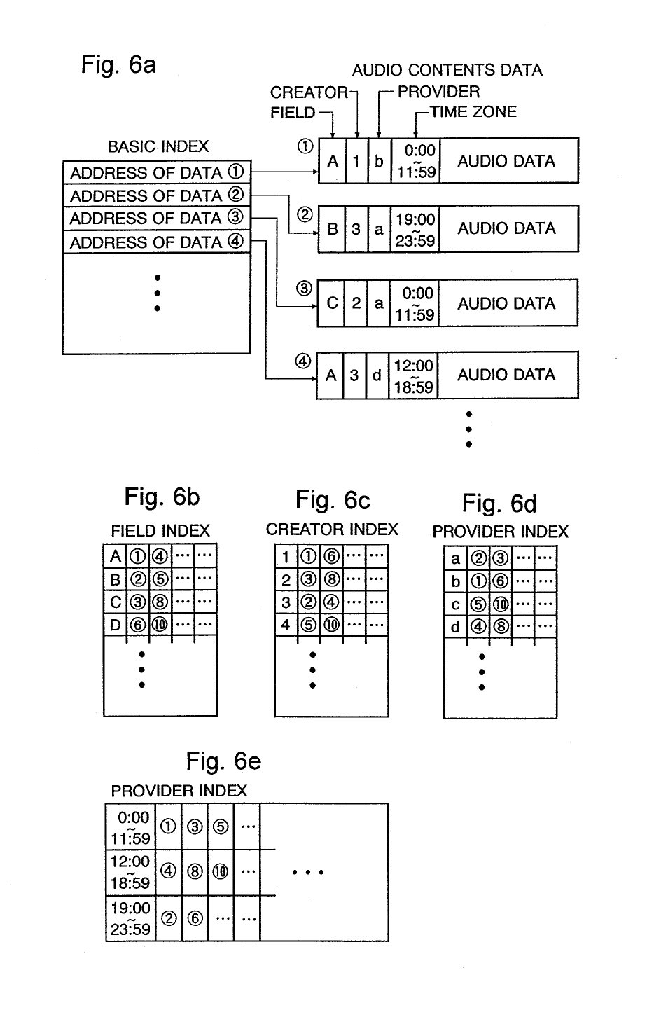

These various content data are placed under the management using the basic index and each category index. FIG. 6a indicates the management structure based on the basic index of various content data. FIGS. 6b to 6e indicate the management structures based on a plurality of category indices. As shown in FIG. 6a, each record of the basic index records the address of audio content data file and therefore direct reference can be made to each audio content data file from this basic index.

In the audio content download system of the present embodiment, reference is made to the basic index at the time of starting the program to automatically generate the category index. As the category index, four index files of the field index (FIG. 6b), creator index (FIG. 6c), provider index (FIG. 6d) and time zone index (FIG. 6e) are generated corresponding to the four kinds of identification data as illustrated in FIG. 6b to FIG. 6e. Namely, at the time of starting, reference is made to all audio content data in the sequence of address in the basic index to collect the identification codes and these are sorted in the secondary arrangement to generate rearranged category index. Each audio content data is sorted and registered into the relevant identification data of each category index, for example, into the “A” of the field index.

For example, as shown in FIGS. 6a to 6e, since the audio content data “(1)” has, as the identification data, the field data “A”, creator data “1”, provider data “b” and time zone “0:00 to 11:59”, the audio content data “(1)” is sorted and registered respectively to “A” of field index, “1” of creator index, “b” of provider index, and “0:00to 11:59” of time zone index. The other audio content data are also registered sequentially to each category index as explained above. Reference to the audio content data from the evaluation value during execution of the audio download program is effected by making reference to the category index.

As explained above, the present embodiment provides an advantage that management of audio content data is performed with the basic index until a program is started and the category index is automatically generated from the basic index when the program is started, addition, deletion and alteration or the like of the audio content data may be realized only with addition, deletion and alteration of the data as the reference destination to the basic index and thereby maintenance work can be very simplified.

Format of Evaluation Value:

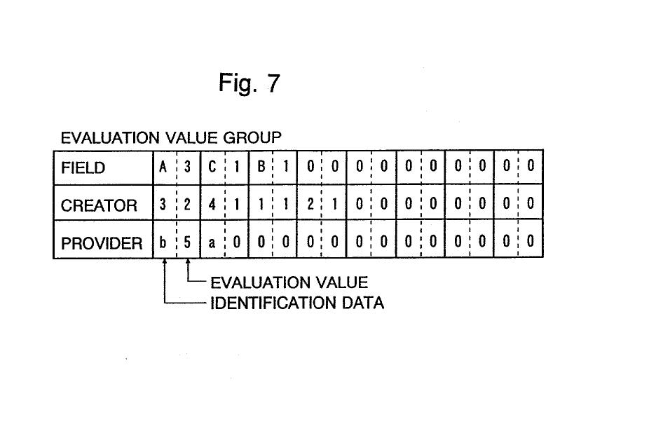

The evaluation value indicates the user selection criterion to various audio content data and is placed under the management for each user. Namely, the user data is composed of a personal data such as name, user ID and password or the like as the peculiar value, and the evaluation value group of such user. FIG. 7 schematically illustrates an example of content of the evaluation value group of each user.

As shown in FIG. 7, the identification data regarding the audio content data and the corresponding evaluation value are stored in the evaluation value storing table of the storage unit 102. Namely, in FIG. 7, the evaluation value group is sorted for every identification data (field data, creator data, provider data) and one section of the evaluation value group has a pair structure including the identification data in the left side and the evaluation value in the right side. For example, the evaluation value for the field data “A” is “3”, the evaluation value for the field data “C” is “1” and the evaluation data for the field data “B” is “1”.

Namely, in the present embodiment, it is indicated that the content data of field data “A” is selected for three times, the content data of field data “C” is selected once for and content data of field data “B” is also selected once, namely the evaluation value is increased corresponding to the respective number of times of selection (increment). This process is also applied to the creator data and provider data. When the incoming data including information of skip operation by the user is arrived from a user terminal, the evaluation value is reduced for only one (decrement). For example, in an example shown in the figure, it is reflected that the field data and creator data are used for six times (total of each evaluation value becomes “6”) but since the evaluation value of provider data “b” is “5”, evaluation value of provider data “a” is “0” and the total of the evaluation values is “5”, the skip operation of the user is attempted once for the provider data “a”.

Selection/Reproduction Process of Audio Content Data:

FIG. 3 is a flowchart of the audio content reproducing process. First, when incoming from the user terminal is identified (S301), a task is started to reproduce the basic guidance and transmit it to the user terminal (S302). The basic guidance is one of the advertisement contents in the present invention and includes the audio content data corresponding to the opening message such as “Thank you very much for your calling. This service . . . ” and the audio content data or the like of the basic operation guidance.

After the process of this step S302, the evaluation value of the audio content data of the basic operation guidance is calculated (S303). Details of the evaluation value calculating process will be explained later.

Then, input of the user ID and password from a user is then accepted and a user is authenticated with the terminated input information (S304). When the user is identified, the log data of the relevant user is read from the log recording unit and if there is the application information in the past, the evaluation value is set (S305).

Then, the current time is acquired with the hardware timer acquiring unit 205 (S306). From the current time and evaluation value acquired, the advertisement audio content data, for example, “Now, the time for introducing the new discs!! Next week, the new disc “X X” of “∘∘” will be on sale! The music you are listening is . . . ” is selected (S307) and its reproduced audio signal is transmitted to the user terminal (S308). Here, the advertisement audio content data is selected as follows. First, the audio content data corresponding to the time zone to which the current time belongs are selected from the user evaluation value group. From such audio content data, the advertisement audio content data of the lower evaluation value is selected from such data based on the respective data of field data, creator data and provide data or the like. When there are a plurality of relevant content data, the first corresponding audio content data is reproduced and is then transmitted. The operation for a plurality of the corresponding audio content data is not limited thereto.

After transmission of the advertisement audio content, the evaluation value regarding the transmitted advertisement audio content data is calculated (S309).

Then, as the background audio content data, for example, the program guidance such as “Today's menu includes “∘∘” as 1, “X X” as 2 and “ΔΔ” as 3. Actually, from NN o'clock of today . . . ” is reproduced and is then transmitted to the user terminal (S310). Thereafter, the evaluation value regarding the background content data of the program guidance is calculated (S311). Here, the mode is switched to the condition to wait for the input at the user terminal (S312) and measurement of progress time is started with the software timer measuring unit 204 (S313).

When the operation input information from the user terminal is appearing in the incoming data, the progress time measured at this timing is acquired (S314). The requested program audio content data is identified from the operation input information such as the button number depressed at the user terminal side and this program audio content data is selected by making reference to the category index (S315). In this case, the evaluation value regarding the selected program audio content data is simultaneously calculated (S316).

When calculation of evaluation value is completed, the selected program audio content data is reproduced and is then transmitted to the user terminal (S317). When transmission is completed, the determination process is executed in the step S318 and when the operation input information for requesting download of another content from the same user is subsequently terminated, the process returns to the step S308 or step S310 to continue the process. When the operation input information about the end of reception is terminated from the user terminal, the evaluation value after the update for the same user is stored in the recording apparatus 102 (S319) and thereafter the process is completed.

Evaluation Value Calculating Process:

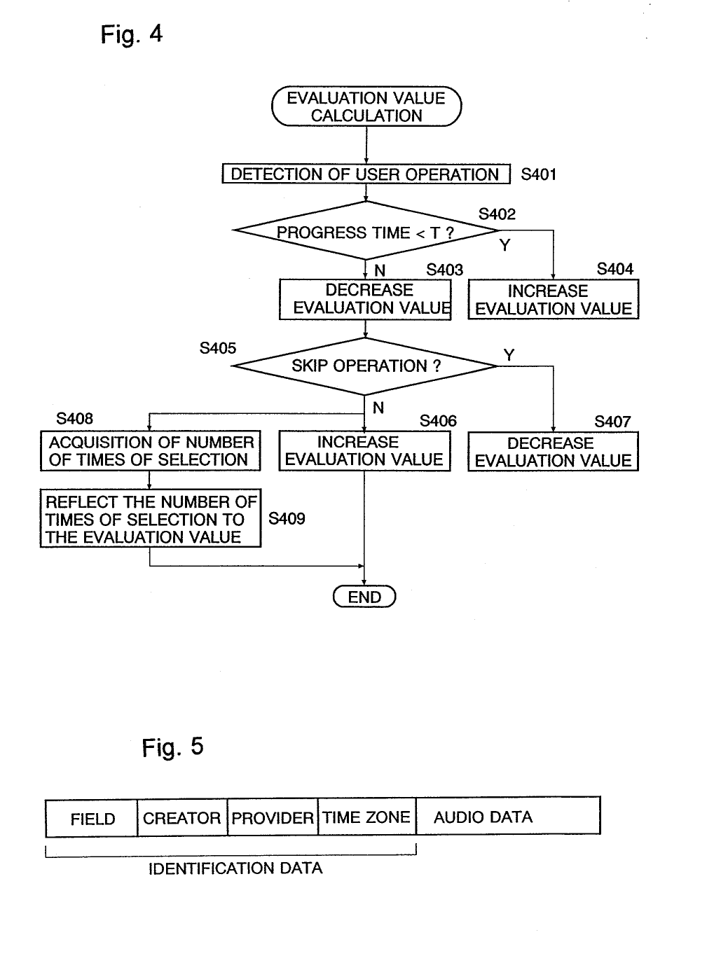

FIG. 4 is a flowchart illustrating an example of the evaluation value calculating process. First, when the operation input information from the user terminal is detected (S401), it is determined whether the progress time acquired at this timing is longer than the preset reference time t or not (S402). When the progress time is shorter than the reference time t (response is fast), the evaluation value regarding the selected audio content data is increased (S404). When the progress time is longer than the reference time t (response is slow), the evaluation value regarding the selected audio content data is decreased (S405). In this embodiment, the evaluation value is increased or decreased by determining that whether the progress time is longer than the reference time t or not, but it is also possible to increase or decrease the evaluation value in a plurality of steps by setting a plurality of reference times. In this case, more detail evaluation values can be set and updated.

In the process for calculating the evaluation values regarding the advertisement audio content data and background audio content data (program guidance content data)(S303, S309, S311), it is preferable that the progress time is defined as the period until the input of skip operation at the user terminal from the reproduction start time of each content data. Moreover, in the process to calculate the evaluation value regarding the program audio content data (main content) (S313), it is preferable that the progress time is defined as the period until incoming of the operation input for selecting the main content from the time of waiting for the input at the user terminal.

Then, when it is determined, from the incoming data, that the detected user operation input information is the information corresponding to the skip operation (S405) and it is detected as the skip operation, the evaluation value regarding the selected audio content data is reduced (S407). When the information does not correspond to the skip operation, it is determined that the selected audio content data is received with the user terminal until the end of data and the evaluation value regarding the selected audio content data is increased (S406). In this case, in the process for calculating the evaluation value regarding the program audio content data (S313), the number of times of the program audio content data of the same field data is acquired from the log data and the number of times of selection is reflected on the evaluation value regarding the program audio content data of the same kind (S408, S409). Thereby, the preference of the user is reflected on the evaluation value.

In this embodiment, it is determined that the larger the evaluation value of content is, the higher a degree of recognition of the user is, therefore it is used for selection of the audio content data at the time of the next download. For example, since a degree of recognition of the user to the provider is determined as higher when the evaluation value of the particular provider data is high, a degree of recognition of the user to the provider is determined high, the particular audio content data not yet downloaded among the audio content data of such provider is determined based on the log data and the evaluation value of such audio content data not yet downloaded is reduced. Thereby, it is now possible to preferably select the audio content data not yet downloaded of the same provider and to transmit such data to user at the time of the next download.

Moreover, when the evaluation value of the particular provider data is low, since a degree of recognition of the user to such provider is determined low, the evaluation value regarding the audio content data of such provider is lowered. Thereby, it is now possible to preferably select the audio content data of the same provider is selected and transmitted to the user at the time of next download in order to realize the advertisement to users of the provider that is not recognized so deeply by users.

As explained above, in the present embodiment, the evaluation values regarding various audio content data are set for respective users and the evaluation values regarding the transmitted audio content data is updated each time and the audio content data is selectively downloaded based on the updated evaluation value at the time of the next download. Therefore, audio content data can be downloaded based on the interest and preference of the users.

In the aboveˆ mentioned embodiment, the audio content data of low evaluation value is selected with the selection reproducing process but the present invention not limited thereto and allows selection audio content data having higher evaluation value.

In addition, in this embodiment, the audio content data is downloaded but it is also possible to download the contents of still images and moving images.

Moreover, in the above-mentioned embodiment, the content data is downloaded to the users of the cellular phone or PHS by means of the public telephone network, but it is also possible to download the content data to the user's computers which are making access through the Internet.

What is claimed is:

1. A content download system for downloading at least one main content requested by a user terminal together with at least one advertisement content to said user terminal on the basis of the access from said user terminal, said system comprising:
input unit means for entering the incoming data from the user terminal into said system;
log recorder means for recording, as the log data intrinsic for said user terminal, the information appearing in the incoming data which corresponds to the input operation at the user terminal;
data storage means for storing identification data of a plurality of main contents and advertisement contents as well as a plurality of evaluation values for said identification data, each of said evaliation values indicating the intrinsic selection criterion by the user for each of the main contents and advertisement contents stored in said data storage means;
selection processor means for selecting an advertisement content on the basis of at least one of said evaluation values;
output unit means for transmitting a main content requested by the user terminal to an address of the user terminal and also transmitting to said address of the user terminal an advertisement content independently selected by said selection processor means in addition to transmission of the requested main content;
measuring means for measuring the time passed from a predetermined period to a point in time when the operational input is made at the user terminal; and
evaluation value calculation means for updating the evaluation values on the basis of said log data and said measured time obtained by said measuring means.

2. A content download system according to claim 1, wherein said output unit means is adapted to transmit to the user terminal the advertisement content selected by said selection processor unit during the period until the content request in the incoming data from user terminal is acquired into the input unit means.

3. A content download system according to claim 1, wherein the log data recorded in the log recording unit includes the information regarding the number of times of selection in the past of each user terminal to said requested main content and wherein said evaluation value calculation means is adapted to update the information regarding the number of times of selection and evaluation value stored in the data storage means based on said progress time whenever access to the system is made at the user terminal.

4. A content download system according to claim 1, wherein the log data recorded in the log recorder means includes the information regarding the canceling operation at the user terminal against the main content and/or advertisement content transmitted to said user terminal and wherein the evaluation value calculating means is adapted to update, whenever access to the system is made at user terminal, the evaluation value stored in the data storage means based on the information regarding canceling operation and said progress time.

5. A content download system according to claim 1, wherein said measuring means is adapted to measure the progress time from a point in time when it becomes possible that the operation input information from the user terminal is detected in the input unit means to a point in time when a content request appears in the incoming data.

6. A content download system according to claim 1, wherein said measuring means is adapted to measure the progress time from a point in time when transmission of advertisement content is started to a point in time when the information regarding canceling operation against the advertisement content at the user terminal appears in the incoming data.

7. A content download system according to claim 1, further comprising a timer means and a timer acquiring unit for acquiring, from said timer means, the current time at a point in time when the information regarding operation input at the user terminal appears in the incoming data, wherein said advertisement content is accompanied with an identification data of the time range and said selection processor means is adapted to select the advertisement content to be downloaded on the basis of said evaluation value and said identification data in a time range to which said current time belongs.

8. A method for downloading at least one main content requested by a user terminal together with at least one advertisement content to said user terminal on the basis of the access from said user terminal, said method comprising the steps of:
entering the incoming data from the user terminal;
recording, as a log data intrinsic for said user terminal, the information appearing in the incoming data which information corresponds to the input operation at the user terminal;
selecting the advertisement content on the basis of an evaluation value indicating an intrinsic selection criterion of the main content and advertisement content for said user terminal;
transmitting the selected advertisement content to said user terminal during the period until the content request information appears in the incoming data from said user terminal, and transmitting the requested main content to said user terminal when the content request information appears in the incoming data;
measuring the progress time from a point in time when transmission of the selected advertisement content or requested main content is started to a point in time when the information regarding operation input at said user terminal appears in the incoming data from said user terminals; and
updating said evaluation value on the basis of said log data and said progress time.

9. A method according to claim 8, further comprising the step of acquiring the current time at a point in time when the information regarding operation input at said user terminal appears in the incoming data from said user terminal, wherein said advertisement content is accompanied with an identification data of the time range and is selected on the basis of said evaluation value and said identification data in a time range to which said current time belongs.

10. A computer-readable recording medium containing a recorded data of a computer software program for executing on a computer the content download method as set forth in claim 8.

11. A computer-readable recording medium containing a recorded data of a computer software program for executing on a computer the content download method as set forth in claim 9.
